(19) United States
(12) Patent Application Publication
(10) Pub. No.: US 2026/0318876 A1
(43) Pub. Date: Oct. 15, 2026

(54) METHODS AND SYSTEMS FOR SINGLE TRACK LOCATION MULTI-FREQUENCY VISCOELASTICITY IMAGING WITH PLANE-WAVE IMAGE COMPOUNDING

(71) Applicant: UNIVERSITY OF ROCHESTER, Rochester, NY (US)

(72) Inventors: Siladitya KHAN, Rochester, NY (US); Stephen MCALEAVEY, Rochester, NY (US)

(21) Appl. No.: 19/551,000

(22) Filed: Feb. 26, 2026

Related U.S. Application Data
(60) Provisional application No. 63/788,230, filed on Apr. 14, 2025.

(51) Int. Cl. G01N 29/06; G01N 29/04; G01N 29/11; G01N 29/46

(52) U.S. Cl. CPC G01N 29/0654; G01N 29/043; G01N 29/11; G01N 29/46; G01N 2291/015; G01N 2291/02818; G01N 2291/02827; G01N 2291/0422

(57) ABSTRACT

A non-invasive quantitative viscoelastic imaging system with Acoustic Radiation Force (ARF) shear wave elastography for parametric imaging of mechanical properties of biological tissues is described. Mechanical properties of pathologies are often tied to their stage and extent of spread, which can be mapped non-invasively with the described elasticity imaging methods.

This application claims priority to U.S. Provisional application 63/788,230 filed on Apr. 14, 2025, the contents of which are incorporated herein by reference in their entirety and for all purposes.

### FIELD

This application relates to the field of ultrasound shearwave elastography (USWE).

### BACKGROUND

Traditional ARFI imaging displays the tissue displacement by about 1-2 ms after excitation around the region where the tissue was excited. However, ARFI mode alone conveys qualitative tissue stiffness information derived from displacement information. Shear-wave elastography overcomes this limitation by tracking the shear waves away from the excitation zone induced by a similar ARF push. The displacement caused by the impulse excitation followed by very high frame-rate doppler style displacement capture at the micron scale provides a more quantitative estimate of shearwave speed, which can be related to tissue stiffness through a linear elastic model. However, tissues are viscoelastic. Hence, the originating shear waves undergo wave-front broadening and attenuation as they propagate. Plane-wave coherent compounding technique and the synthetic aperture focus have made high frame-rate ultrasonography possible, creating new opportunities in ultrasound imaging. However, the “speckle-bias” of the tracked beam remains unaddressed. A “bright” off-axis speckle throws off the displacement estimates, ultimately leading to mis-estimation of the apparent stiffness parameter used for quantification in elastography.

Single Track Location Shear Wave Elasticity Imaging (STL-SWEI) uses a common track line that negates the impact of this bias by using two spatially offset ARF excitations for each tracking line of an imaging ensemble. STL-SWEI has traditionally been designed with focussed tracking beams. However, efforts have been directed to leverage the advantages of high frame rate plane wave tracking to STL-SWEI. Hence, plane-wave STL (p-STL) SWEI was proposed that brought the capability to perform simultaneous tracking with multiple unfocussed plane waves whose raw echo-data set was “coherently” summed to achieve acceptable performance metrics in terms of Signal-to-Noise (SNR), Contrast, and Resolution to match conventional STL-SWEI. Nevertheless, the estimation was still limited to an elastic wave formulation that fails to account for viscosity, an essential parameter in many pathological scenarios, and ultimately injects bias into rheological measurements of tissues.

### SUMMARY

An aspect of the present application relates to a method of mapping viscoelasticity using Acoustic Radiation Force (ARF) source Single Track Location (STL) shear wave spectroscopic imaging comprising: generating shear waves in a body region of interest in a subject from a plurality of spatially offset locations; tracking the shear waves at a common receiver; measuring frequency-dependent shear wave speed; measuring attenuation of the shear waves; estimating by a crosspower spectral density (CPSD) transfer function a phase shift and an amplitude decay as a function of propagation distance; and constructing multifrequency parametric two-dimensional maps capturing local tissue viscoelasticity.

Another aspect of the present application relates to a method for noise suppression in viscoelasticity imaging, the method comprising: acquiring a plurality of viscoelastic displacement datasets from a single track location (STL) imaging sequence using plane-wave imaging with multiple steered insonification angles; forming, from the plurality of viscoelastic displacement datasets, a compounded in-phase quadrature (IQ) dataset; estimating displacement fields from the compounded IQ dataset using a two-dimensional (2D) autocorrelation-based displacement estimator; discarding a subset of the compounded IQ dataset that fails to meet a predefined minimum energy threshold to eliminate noise-corrupted data frames; applying a directional spatial frequency filter to the estimated displacement fields to remove reflected wave artifacts; applying a temporal band-pass filter to the displacement fields to isolate frequencies within a target bandwidth; computing a complex shear modulus of a medium by performing a frequency-domain transfer function analysis between a first and second shear wavefield generated by acoustic radiation force (ARF) pushes at spatially offset locations; estimating, for each pixel of the imaging field, a storage modulus and a loss modulus as a function of shear wave dispersion and attenuation over the frequency bandwidth; averaging the storage modulus and the loss modulus pixel-wise based on a cross-correlation coefficient derived from the shear wavefields; calculating a magnitude squared coherence (MSC) parameter at each frequency band using a periodogram-based estimator to determine the coherence between the tracked shear waves from the first and second ARF pushes; generating a quality map based on the MSC parameter across the frequency spectrum; and suppressing noise in the final viscoelastogram by weighting, enhancing, or masking the storage and loss modulus estimates based on the frequency-dependent quality map.

Another aspect of the present application relates to a method for quality assessment and noise suppression in viscoelasticity imaging, the method comprising: acquiring a plurality of displacement wavefields generated from a pair of acoustic radiation force (ARF) PUSH events applied at spatially offset locations in a single track location (STL) imaging sequence; tracking shear wave propagation from the ARF PUSH events using plane-wave imaging at multiple steered angles to generate echo data; forming a compounded in-phase quadrature (IQ) dataset from the echo data; estimating displacement fields from the compounded IQ dataset using an autocorrelation-based displacement estimator; calculating, at each spatial location and over a range of frequencies, a magnitude squared coherence (MSC) parameter between a first and a second tracked shear wavefield, wherein the MSC parameter is computed as the cross-spectral density between the two wavefields normalized by the auto-spectral densities of the individual wavefields; generating a frequency-dependent quality map across an imaging field-of-view (FOV) based on the MSC parameter; computing, for each pixel in the FOV, viscoelastic parameters including a storage modulus and a loss modulus derived from a frequency-domain transfer function based on the displacement field; and suppressing noise in the computed viscoelastic parameters by applying the quality map to enhance, weight, or mask pixel-wise modulus estimates at frequency bands where the MSC parameter indicates low coherence.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present invention will be obtained by reference to the following detailed description that sets forth illustrative embodiments, in which the principles of the invention may be utilized, and the accompanying drawings. The figures herein are for illustrative purposes only and are not necessarily drawn to scale.

FIG. 1 shows Plane-Wave Single-Track Location Shear Wave Elasticity (p-STL) Viscoelasticity Imaging Sequencing Scheme. (a)-(d) A 1st ARF “PUSH” is initiated along the imaging face of the transducer, followed by a 2nd ARF “PUSH” offset spatially by a few pitch elements at a separation distance ΔP and after a time offset of 0.2 milliseconds. Multiple shearwave datasets are then synthesized between the tracked waves initiated by the ARF “PUSH” at the solid green arrow at a particular location indicated by the solid red arrow. The push track pair creates a modulus estimate e1 between the two green arrows. Since the receive acquisition is fully parallel, we can synthesize multiple receive datasets simultaneously utilizing an ensemble of plane wave tracking at tilted angles. The receive location after location 1 is then shifted to its track location, shown by the activation of the solid red arrow between panels (d) and (e), and that creates another estimate e2 followed by e3, e4 as shown in (f). We can then create a weighted estimate ew, which can be seen as an average of all the above estimates [e1, e2, e3, e4] obtained by coherent compounding from the tracked locations. The “PUSH” and parallel plane-wave “TRACK” combination is repeated to cover the imaging field-of-view, as shown in (h), to generate a 2D parametric estimate map of viscoelastic parameters.

FIG. 2 shows ARFI plane-wave STL shearwave spectroscopic viscoelasticity imaging reconstruction pipeline. (A) The experimental setup shows the scan setup with a linear array transducer. (B) Schematic illustrating the p-STL ARFI data acquisition. In the STL scheme, two ARF pushes are applied at the two spatial points XP 1 and XP 2, offset by ΔP. The distance between the 2nd push beam and the 1st track beam is ΔT. As in STL, the generated shear waves are tracked using plane-wave imaging with multiple steered track beam insonifications instead of a fixed-focussed track beam. We follow the convention of synthesizing “TRACK” beams to the left side of the “PUSH” pair. (C) Tracked echo data captured at individual track angles (shown here for three angles) are compounded to form a single In-phase Quadrature (IQ) dataset [Y. Xiao, J. Jin, Y. Yuan, Y. Zhao, and D. Li, “On the Role of Coherent Plane Wave Compounding in Shear Wave Elasticity Imaging: The Convolution Effect and Its Implications,” Ultrasound in Medicine & Biology, vol. 50, no. 2, pp. 198-206, 2024]. (D) The compounded IQ dataset is then used to compute the speckle correlation displacement field using the Loupas-2D autocorrelation algorithm. (E) The displacement wavefield is used for downstream viscoelasticity processing using the Cross-power Spectral Density Estimator. (F) Rendered 2D multi-frequency μE, μS(ω), and μL(ω) elastograms.

FIG. 3 shows computation of Magnitude Squared Coherence (MSC) between a pair of shearwave traces in STL configuration. (A) Simulated shearwave traces generated by sources 1 and 2 with a spatial offset. (B) Normalized Correlation Coefficient (NCC) between the wave pairs showing the peak time delay between wave traces in (A). (C) MSC between the shearwave traces indicating a region of frequency bandwidth showing high MSC.

FIG. 4 shows (A) and (B) shows the setup and an ex vivo animal tissue sample of 20 mm diameter being prepared for the dynamic shear oscillatory test using a rheometer in parallel plate configuration.

FIG. 5 shows elastograms of a 10 mm circular gelatin target embedded in a viscoelastic oil-in-gelatin background. Panel images to the left (A and D) show the storage modulus elastogram rendition at a shearwave frequency of 200 Hz and 600 Hz. Central image panels (B) and (E) display the loss modulus image of the target at 200 Hz and 600 Hz. Image panels (C) and (F) show the MSC plot of the wavefield acquired from the p-STL dataset at 200 Hz and 600 Hz. (G) shows a linear elastogram image of the target using a cross-correlation estimator. Panel (H) shows the magnitude of the complex shear modulus pixels of the inclusion target resolved over a discrete multi-frequency range of 100 Hz up to 800 Hz. Panel (I) shows the Contrast Ratio computed at multiple frequencies of the elastogram using the pixels of the 10 mm inclusion target and a 5 mm×2 mm bounding box covering the surrounding background.

FIG. 6 shows elastograms of bi-layer phantom. (A) Linear modulus elastogram showing Layer 1 and Layer 2. (B) MSC (C) storage (D) loss modulus maps at 850 Hz. The magnitude of complex shear modulus for (E) Layer 1 and (F) Layer 2. (G) The mean complex shear modulus ratio between Layer 2 and Layer 1 over frequency.

FIG. 7 shows representative images showing analysis of a soft-boiled chicken egg phantom scanned underwater for viscoelasticity imaging. (A) B-mode image showing various anatomic regions such as the egg white and yolk. (B) Elastic modulus image (C) Average stiffness values are shown for ROI demarcated by two white boxes for the region around egg white (top) and the yolk (bottom) plotted as a function of shear wave frequency of 100-1000 Hz. (D-F) Parametric maps of storage modulus, loss modulus, and coherence at 100 Hz showcasing spatial stiffness variations within the egg phantom. (G-I) Corresponding maps at 250 Hz.

FIG. 8 shows elastograms of an ex vivo a rabbit liver lobe embedded in a gelatin background. Panel images to the left (A and D) show the storage modulus elastogram rendition at a shearwave frequency of 200 Hz and 600 Hz. Central image panels (B) and (E) display the loss modulus image of the target at 200 Hz and 600 Hz. Image panels (C) and (F) show the Magnitude Squared Coherence (MSC) plot of the wavefield acquired from the p-STL dataset at 200 Hz and 600 Hz. (G) shows a linear elastogram image of the target using a cross-correlation estimator. Panel (H) shows a B-mode echogenicity image of the rabbit liver with its surrounding background. Panel (I) shows the magnitude of the complex shear modulus pixels of the liver target within the bounding box resolved over a discrete multi-frequency range of 100 Hz up to 600 Hz.

FIG. 9 shows ex vivo human placenta imaging results in a water bath. Panel (A) shows the linear shear modulus elastogram. Panels (B) and (C) show storage and loss modulus elastograms at a reconstruction frequency of 350 Hz. MSC map converted to dB scale in Panel (D). Note the false color bar scale change to a Log converted map. (F) A B-mode image of the tissue and specific ROI is shown around an infarct, plotting the average modulus over frequency.

FIG. 10 shows frequency-sweep harmonic shear oscillation test on an ex vivo (A) rabbit liver, and (B) human placenta sample. The shear moduli and the loss tangent are plotted against the linear frequency range over which the frequency sweep experiment was conducted. The region in yellow in both panels denotes the actual experimental axial frequency range that was excited on the sample allowed by the instrument in frequency sweep mode between 6×10−5 rad/s to 100 rad/s (10−5 Hz to 16 Hz). The region in blue indicates the data extrapolated in the instrument report by the Time-Temperature Superposition (TTS) principle.

FIG. 11 shows B-mode and overlaid shear modulus images in in vivo mouse 1. (A) and (B) Storage and Loss modulus images reconstructed at 400 Hz. (C) and (D) at 500 Hz. (E) and (F) shows corresponding MSC images at 400 and 500 Hz, respectively. (G) The linear shear modulus image, with the annotated bounding box for viscoelastic analysis, is indicated in white. (I) The magnitude of complex shear modulus over frequency reconstructed between 100-1000 Hz.

FIG. 12 shows B-mode and overlaid shear modulus images in in vivo mouse 2. (A) and (B) Storage and Loss modulus images reconstructed at 200 Hz. (C) and (D) at 600 Hz. (E) and (F) shows corresponding MSC images at 200 and 600 Hz, respectively. (G) The linear shear modulus image, with the annotated bounding box for viscoelastic analysis, is indicated in white. (I) The magnitude of complex shear modulus over frequency reconstructed between 100-1000 Hz.

FIG. 13 shows repeatable measurements of placental viscoelasticity using p-STL algorithm. Elastography measurements are reported as mean values of the shear viscoelastic modulus (top: storage, mid: loss, bottom: magnitude of complex modulus) within a 10 mm×10 mm ROI across four independent echographic planes L1-L4. (A) Measurements with the fetal surface and (B) maternal surface facing the transducer.

FIG. 14 shows viscoelastic response master curve derived using ultrasonic shear wave analysis in a homogeneous oil-in-gelatin emulsion. (A) shows the magnitude of the complex shear modulus. (B) shows the loss tangent.

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosed invention. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

The terms “subject,” “patient,” and “individual,” are used interchangeably herein to refer to a vertebrate, preferably a mammal, more preferably a human. Mammals include, but are not limited to, murines, simians, humans, farm animals, sport animals, and pets. Tissues, cells and their progeny of a biological entity obtained in vivo or cultured in vitro are also encompassed by such terms. Unless otherwise specified, a “subject,” “patient,” or “individual” refers to both biological male and female vertebrates.

All publications and patents cited in this specification are cited to disclose and describe the methods and/or materials in connection with which the publications are cited. All such publications and patents are herein incorporated by reference as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

### Overview

This application discloses a non-invasive quantitative viscoelastic imaging system with Acoustic Radiation Force (ARF) shear wave elastography for parametric imaging of mechanical properties of biological tissues. Mechanical properties of pathologies are often tied to their stage and extent of spread, which can be mapped non-invasively with elasticity imaging methods. However, the mechanical viscosity may often confound measurements in traditional elasticity estimators, especially in diseases that accumulate purulence.

The imaging system measures shear wave propagation within tissues and quantifies the propagation speed and the wave attenuation on excitation frequency. This application discloses a plane-wave Single Track Location (p-STL) approach to detect the ARF-induced displacements using coherent compounding of multiple plane ultrasonic wave insonifications. Viscoelastic parameters of the medium are reconstructed using a cross-spectral transfer function approach that generates multi-frequency parametric images of the shear stiffness of tissues. This application discloses a shearwave quality metric based on mutual coherence of the temporal shearwave data that isolates regions of shearwave decorrelation artifacts in parametric imaging at various shearwave frequencies. The method is validated on in vitro cultured phantoms, ex vivo rabbit livers, and human placenta, and in vivo pre-clinical imaging of mice livers.

In contrast to previously described methods that produce a single estimate for shear wave spectral parameters over an extended ROI, this application has demonstrated the feasibility of pixel-wise shear wave speed and attenuation imaging using an STL imaging approach. Importantly, this method reveals tissue contrast that is not visible in images of elastic shear modulus derived from shear wave group speed.

Plane Wave STL (p-STL) Elastography Sequence

STL techniques suppress speckle noise present in conventional multiple-track location (MTL) imaging. STL compares the arrival times of shear waves at a common track beam location. Plane-wave imaging allows multiple track locations to be interrogated simultaneously. Received echoes are processed parallel and coherently compounded to produce a displacement estimate. p-STL employs a parallel receive scheme to track the shear waves but still performs STL-style shear wave speed estimation at multiple tracking sites simultaneously, resulting in multiple synthesized STL datasets. There is a 1.5-fold improvement in elastographic SNR in pure elastic phantoms by acquiring multiple independent measurements of the shear wave field.

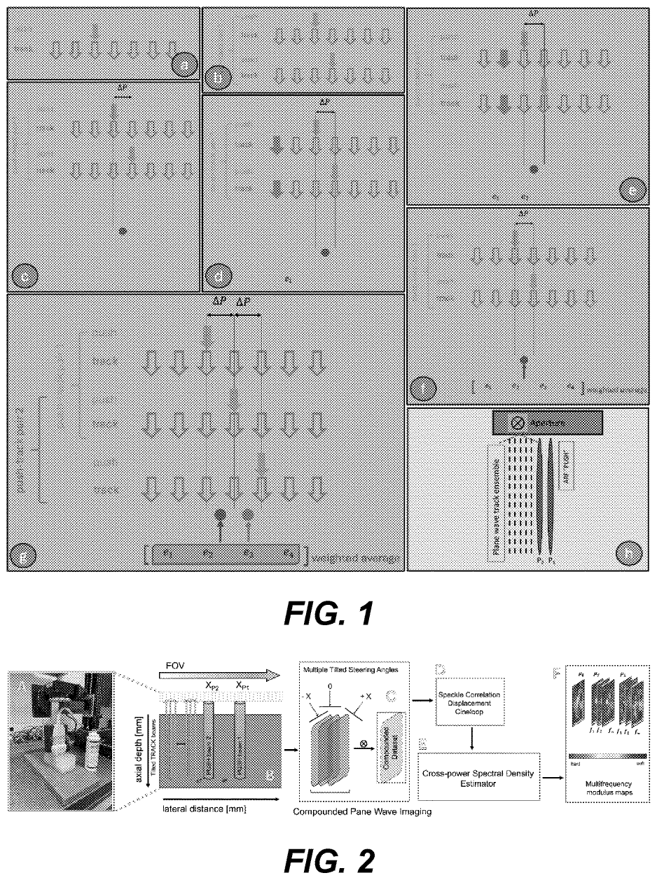

FIG. 1 shows a p-STL acquisition sequence schematic. The “PUSH” (indicated by solid green arrows in the panels) refers to a radiation force insonification event. A sequence of two ARF beams separated by a distance ΔP, the distance between push beams in a single such “PUSH” event. Returning echoes after insonification are collected by a “TRACK” event distributed across the entire field of view (shown by unfilled red arrows), each with a separation distance of ΔT, known as the track beam spacing. Each track beam is formed from multiple tilted plane waves fired from the aperture, as shown schematically in Panel (h). The collected RF echo data from multiple angles are coherently compounded to produce a detected “TRACK” line. This tracked dataset possesses superior radio frequency (RF) echo SNR, enabling a more robust tissue displacement estimate. This displacement estimate is produced by averaging across the multiple tracking realizations, unlike traditional STL-SWEI track events, which employ fixed-focus interrogations to track the displacement of the speckle disturbed by the ARF, producing a single SWEI estimate. Multiple STL-SWEI datasets may be synthesized in p-STL by choosing appropriate combinations of waves collected at several track locations selected sequentially (indicated by a solid red arrow) as shown in Panels (d) through (g). Since the shearwave estimate collected by the p-STL is collected over many such “TRACK” events, each containing independent, uncorrelated noise, averaging can produce elastograms with better elastographic SNR.

TABLE I
BEAM PARAMETERS FOR p-STL
ELASTOGRAPHY ACQUISITIONS.

| Parameters | Push | Track |
|---|---|---|
| Transmit frequency (MHz) | 5-10 | 5 |
| Pulse Duration (μs) | 150-400 | 0.2 |
| F # | 2 | 2 |
| Transmit voltage (V) | 38 | 38 |
| Steering Track Angles (o) | — | [−4/−1, 0, +4/+1] |
| Focus (mm) | [10, 15, 20, 25] | 20/30 |
| PRF (KHz) | — | 7/10 |

### Viscoelasticity Reconstruction & Elastogram Processing

p-STL elasticity data acquisition was performed on the Verasonics Vantage 64LE ultrasound research platform (Verasonics Inc., Kirkland, WA, USA) for phantoms and ex vivo and 128LE systems for in vivo studies that are used to drive an ATL L7-4 and an L11-5v 128-element linear array transducer respectively. The scan parameters are described in Table I. Downstream viscoelastic processing was conducted offline to generate modulus maps on a composite wavefield by weighting the datasets corresponding to “TRACK” events based on the energy content of the tracked shear waves. The pushes were delivered by setting ΔP to 0.7 mm, with track spacing ΔT varied between 4 mm and 9 mm based on an acquisition. The selected tracked echo data set was software beamformed using the Delay-and-Sum (DAS) beamforming method implemented in MATLAB-2020a (Mathworks, Natick, MA) with accelerated computations using a GPU (NVIDIA Tesla A40 GPU with 48 GB of memory) [V. Perrot, M. Polichetti, F. Varray, and D. Garcia, “So you think you can DAS? A viewpoint on delay-and-sum beamforming,” Ultrasonics, vol. 111, p. 106309, 2021]. The raw channel data was converted to In-phase-Quadrature (IQ) data set and was used for displacement estimation using the Loupas-2D estimator [T. Loupas, J. T. Powers, and R. W. Gill, “An axial velocity estimator for ultrasound blood flow imaging, based on a full evaluation of the Doppler equation by means of a two-dimensional autocorrelation approach,” IEEE Transactions on Ultrasonics, Ferroelectrics, and Frequency Control, vol. 42, no. 4, pp. 672-688, July 1995] using an axial and slow-time ensemble of [5, 5], respectively with progressive referencing. The stuidy synthesized 16-30 STL-style datasets based on the acquisition event. As shown in Algorithm 1, the study removed the first two IQ pages of the 4D spatiotemporal dataset conditioned on a minimum energy threshold since they were corrupted by machine noise. The displacement dataset was directionally filtered in the spatial frequency domain [T. Deffieux, J.-L. Gennisson, J. Bercoff, and M. Tanter, “On the effects of reflected waves in transient shear wave elastography,” IEEE Transactions on Ultrasonics, Ferroelectrics, and Frequency Control, vol. 58, no. 10, pp. 2032-2035, 2011] to exclude reflected wave artifacts and 2nd order band-pass filtered to 50-1500 Hz in the temporal frequency domain. The complex shear modulus of the medium was estimated using a frequency-domain transfer function approach [S. Khan, S. Goswami, F. Feng, S. Hollenbach, M. M. Doyley and S. A. McAleavey, “Probing Tissue Viscoelasticity With STL Ultrasound Shearwave Spectroscopy Using Cole-Cole Diagrams,” in IEEE Transactions on Biomedical Engineering, vol. 71, no. 3, pp. 916-928, March 2024].

Briefly, the frequency-domain transfer function is defined as the cross-power spectral density (CPSD) of the two tracked wavefields as H12(ω), normalized by the auto-spectra of the first shear wavefield S1(ω) in an STL-style acquisition event. ω is the angular frequency in the frequency bandwidth, * represents the complex conjugate operation, and ϵ is a tunable parameter that controls the numerical stability of the denominator and is empirically chosen as 1% of the auto-power spectrum term of the first shear wavefield expressed as in Equation 1.

$${H}_{12} ( ω ) = \frac{{S}_{1} ( ω ) \times {S}_{2}^{*} ( ω )}{[ {S}_{1} ( ω ) \times {S}_{1}^{*} ( ω ) + ϵ ]} = \vert {H}_{12} ( ω ) \vert {e}^{j {Φ}_{12}} \qquad ( 1 )$$

The magnitude and phase of the cross-spectra transfer function are represented by H12 and Φ12, respectively. Using the forward model of plane wave propagation of the shear wave [18], we can estimate the shear storage (μS) and shear loss modulus (μL) expressed as a function of the shear wave dispersion (cΦ(ω)) and attenuation (α(ω)) over the bandwidth as shown in Equation 2.

$${μ}_{S} = ρ {ω}^{2} \frac{\frac{{ω}^{2}}{c Φ} - {α}^{2}}{{( \frac{{ω}^{2}}{c Φ} - {α}^{2} )}^{2}} \qquad ( 2 )$$

$${μ}_{L} = 2 ρ {ω}^{2} \frac{\frac{ω}{c Φ} α}{{( \frac{{ω}^{2}}{c Φ} + {α}^{2} )}^{2}}$$

For each tracked particle displacement wavefield, the pixel-wise storage and loss modulus estimate was averaged by the value of the cross-correlation coefficient of the two tracked waves in the STL using various ΔT settings, leading to a single averaged elastogram estimate for the storage (μS) and loss (μL) modulus respectively as shown in panel (F) of FIG. 2. The weighting proposal is described below.

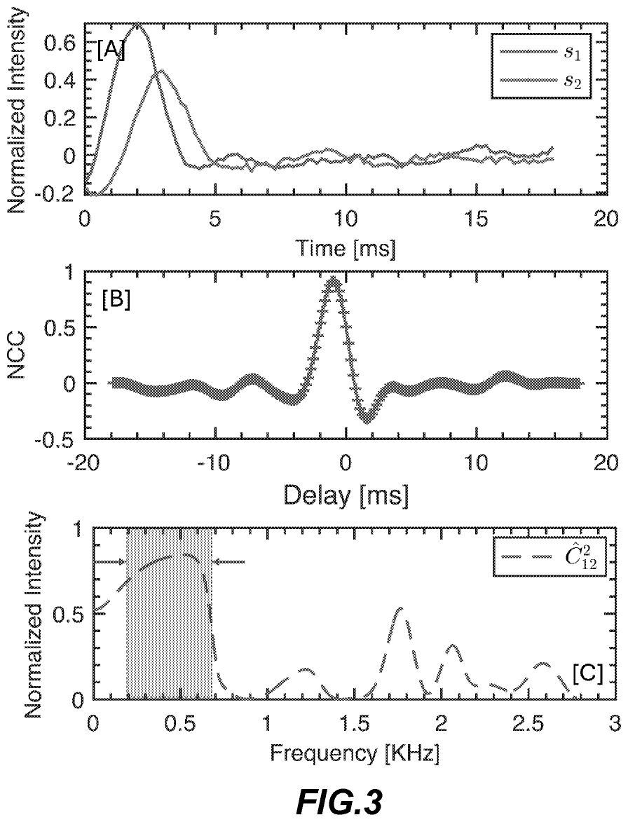

Coherence between p-STL ARF Sources: this study shows the Magnitude Squared Coherence (MSC) estimate to assess the measurement reliability of the tracked shearwave dataset and provide insights into the time-dependent mechanical behavior of interrogated tissues observed over a few milliseconds. MSC is defined by Equation 3 where, \hat{ }P\hat{ }₁₂ represents the cross-spectrum of the shear waves tracked at a location due to pushes “1” and “2”, while P\hat{ }₁₁ and P\hat{ }₂₂ represents the spectra of the individually tracked waves by sources “1” and “2” respectively as shown in FIG. 3 (Panels A and C). MSC value ranges between 0 and 1, quantifying the degree to which the displacements tracked from the first push correspond to those from the second push at specific frequencies. P\hat{ }₁₁ and P\hat{ }₂₂ are normalization factors that control for the fact that waves excited at different spatial locations will have different magnitudes owing to the extra propagation distance equal to spacing ΔP.

While cross-correlation normalized by the energy of the tracked waves (FIG. 3 panel B) is a good estimator to observe and detect motion artifacts or poor SNR of shear waves in an elastic medium, in a viscoelastic medium, the response to ARF pushes varies with frequency due to dispersion and attenuation of waves. Thus, the MSC highlights frequencies where the correlation between shearwave signals is high. In other words, the metric can highlight the frequencies of shearwave signals common to both push locations. Frequency bands with an MSC near unity indicate frequency modes that have been evoked in the particular pair of shearwave signals during propagation between the push points XP1 and XP2 (FIG. 2 Panel (B)), while MSC should be near zero at the frequency modes not excited during propagation or corrupted by poor SNR of the signal.

$${\hat{C}}_{12}^{2} ( ω ) = \frac{{\vert {\hat{P}}_{12} ( ω ) \vert}^{2}}{{\hat{P}}_{11} ( ω ) {\hat{P}}_{22} ( ω )} \qquad ( 3 )$$

Since a common track line is used, the magnitude of the tracked shearwave impacted by the “speckle-bias” effect is negligible, as discussed previously. Therefore, a low MSC at a particular frequency may be attributed to the particular spatial location not getting excited at the particular shearwave frequency or due to shear wave decorrelation resulting from wave dispersion/attenuation or diffraction. The study renders pixel-wise estimates of the MSC parameter implemented by the Welch's overlapped segment averaging (WOSA) periodogram method [mathworks online resource] at each frequency band, which correlates to the modal activation map of the shearwave dataset spatially across the imaging field-of-view (FOV). The study renders the MSC map alongside the elastogram rendering, which enables a quantitative confidence rating of estimates in regions that can be trusted in a viscoelastogram at a particular frequency. This is especially beneficial since viscoelastic estimates are highly susceptible to estimation errors in shearwave attenuation and dispersion. Thus, a frequency-specific quality map proposed by mapping coherence can highlight regions of high viscoelastic activation by a frequency mode or may be used to mask out spatial zones where shearwave analysis is unreliable.

Spatial and Temporal Compounding of Elastograms: The pixel-wise estimates of the frequency-resolved elastograms were subjected to two averaging processes. First, spatial regularization is performed at the pixel level, where each elastogram pixel pᵢ across a FOV (x,z) is weighted based on the normalized cross-correlation (NCC) coefficient between the two shear wave traces up 1 and up 2 that represents waves due to “PUSH-1” and “PUSH-2” at a particular “TRACK” line in an STL acquisition as derived by Equation 4. The. Σᵢ NCC_{i,j}(up₁,up₂)² is the normalization factor, summing over all NCC values for a pixel across tracking lines in a p-STL acquisition.

$${w}_{i} = \frac{{{NCC}_{i} ( {u}_{{p}_{1}} , {u}_{{p}_{2}} )}^{2}}{{\sum }_{j} {{NCC}_{i , j} ( {u}_{{p}_{1}} , {u}_{{p}_{2}} )}^{2}} \qquad ( 4 )$$

The weighted elastogram pixel is simply piw=wi pi. Secondly, we also performed frequency-band averaging for each elastogram up to ±10 samples around a discrete frequency bin to render viscoelastic modulus images similar to [21], where band averaged estimates were performed on phase velocity images to reduce elastogram noise due to the spectral computation.

The study assessed the linear and viscoelastic elastograms qual itatively by visual inspection and quantitatively using the elastographic the contrast ratio (CR_{E})

$${CR}_{E} = ⌈ \frac{{\hat{μ}}_{I}}{{\hat{μ}}_{B}} ⌉ \qquad ( 5 )$$

where μ\hat{μ}_{I}/B represents the mean of elasticity estimates for the inclusion and background.

This study reports elastogram images and metrics for the elastic shear modulus, henceforth referred to as μ_{E} the shear loss, storage, and the overall dynamic modulus at a certain shearwave frequency X denoted by μLₓ, μsₓ, and |μ*∥ₓ respectively

### Dynamic Mechanical Analysis

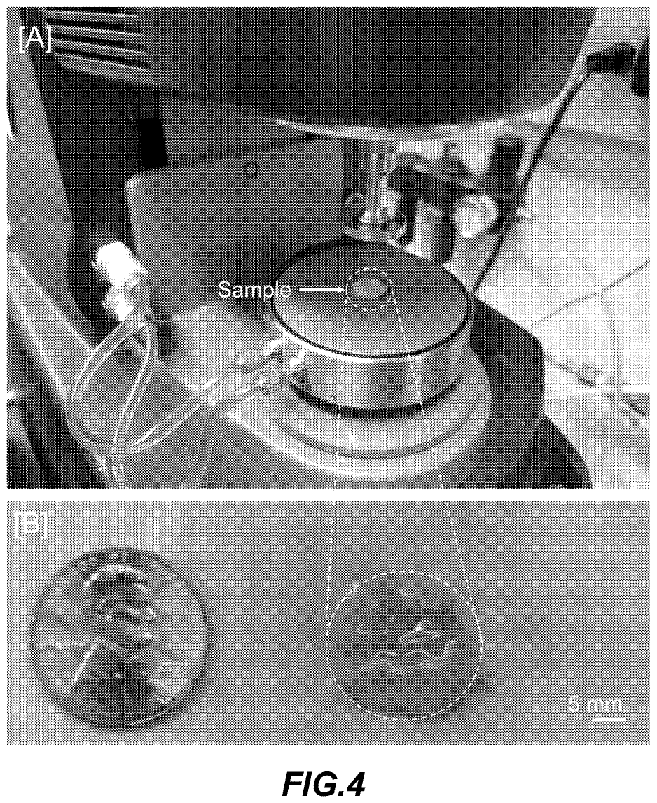

This study reports viscoelastic analysis in Dynamic Mechanical Analysis (DMA) mode with a strain-controlled rheometer setup (SCR) (TA Instruments HR-2 Discovery Hybrid, Delaware, USA) in a 20 mm parallel plate configuration shown in FIG. 4. Although the instrument can report a viscoelastic master curve up to 100 Hz, the range of axial frequency supported by the spindle is up to 100 rad/s, 16 Hz). In contrast to the impulse excitation mechanism as in ARF elastography, the sample is subjected to a sinusoidal shear strain ϵ over a frequency range, resulting in a corresponding shear stress ω shifted in phase. The ratio of which is the complex shear modulus (μ*).

Initially, an amplitude sweep was conducted on the tested sample from 0.01% to 20% strain at a frequency of 5 Hz. After the amplitude sweep, the frequency sweep was conducted at 0.5% strain to capture the viscoelastic fingerprint with the variation of μ_{S} and μ_{L} reported as a function of frequency.

High frequency corresponds to solid-like behavior, and low frequencies manifest liquid-like behavior. The magnitude of the complex modulus and the loss tangent are two important landmarks that characterize the viscoelastic master curve in DMA.

### Further Embodiments

This study demonstrated an ultrasonic measurement of radiation force-induced relaxation behavior of shear waves in viscoelastic tissues. Radiation force impulse excitations last a few hundred microseconds, and the response is captured over tens of milliseconds. The process is iterated in a repeatable imaging ensemble of ARF push and track beams to generate a complete 2D map of tissue viscoelasticity. This study demonstrated that multi-frequency resolved maps of the magnitude of complex shear stiffness can delineate mechanical responses of tissues, which can be locally estimated and portrayed as a parametric image.

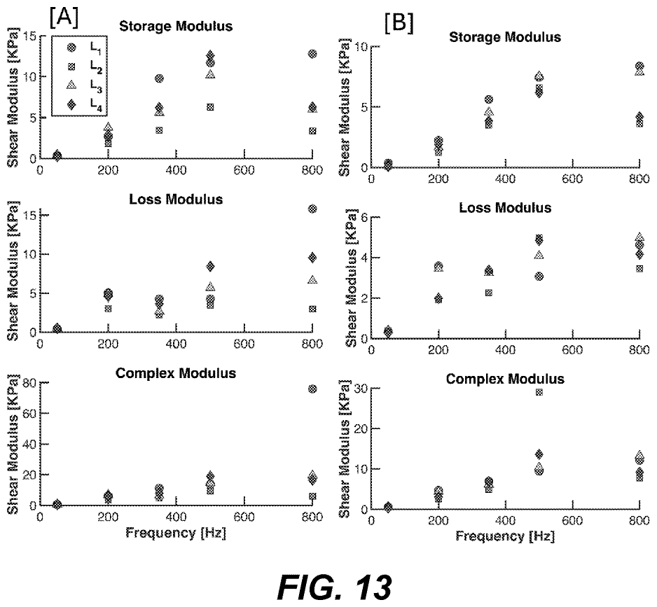

Validating on ex vivo human tissues, we report repeatable measurements of the viscoelastic moduli across the shearwave frequency range as shown in FIG. 13. The response captured across independent echographic planes L₁-L₄ on the maternal and fetal surfaces of the placental tissue facing the transducer agrees well between the measurements. The reported μ* between measurements over the fetal surface is around 20 kPa, while for the maternal surface is around 10 kPa.

The complex shear modulus consists of loss and storage moduli is one of many landmarks that can capture the viscoelastic response. Further embodiments fitting the modulus response to well-known rheology models [K. J. Parker, T. Szabo, and S. Holm, “Towards a consensus on rheological models for elastography in soft tissues,” Physics in Medicine Biology, vol. 64, no. 21, p. 215012, 2019], can be used to generate a parametric map. From modeling parlance, the concept of “parsimony” [D. S. Sivia and John Skilling. Data Analysis: A Bayesian Tutorial. New York: Oxford University Press, 1998] is very powerful when deciding on an appropriate model architecture. When selecting from among competing models, the general favor is for a simple model capable of fitting observed data over a complex model.

In further embodiments, integrating loss tangent parametric maps into the viscoelastic imaging pipeline developed here augment existing viscoelastic parametric imaging. Combining various ARF excitations that generate a complex shear wave field and excite different frequency modes in a tissue are used with local wave number inversion to reconstruct elastogram parameters at a particular modal frequency. Bessel apodized ARF beams provide extended bandwidth of shearwave modes. Further embodiments, integrate an ensemble of ARF excitation apodizations to the existing approach to image several viscoelastic modes. This method is applied to image soft-tissue infections.

An aspect of the present application relates to a method of mapping viscoelasticity using Acoustic Radiation Force (ARF) source Single Track Location (STL) shear wave spectroscopic imaging comprising: generating shear waves in a body region of interest in a subject from a plurality of spatially offset locations; tracking the shear waves at a common receiver; measuring frequency-dependent shear wave speed; measuring attenuation of the shear waves; estimating by a crosspower spectral density (CPSD) transfer function a phase shift and an amplitude decay as a function of propagation distance; and constructing multifrequency parametric two-dimensional maps capturing local tissue viscoelasticity.

In some embodiments, viscoelasticity is resolved over 50-1000 Hz.

In some embodiments, the subject is a mammal.

In some embodiments, the spatially offset locations are in a pair that is laterally shifted sequentially along the body region.

In some embodiments, the method comprises the step of: generating shear waves by an acoustic radiation force “push” that is exerted at two spatial points (a “push-track” pair) at a particular depth, X_{P1} and X_{P2}, which are offset by a specific distance Δp. In some embodiments, the method comprises the step of: tracking the generated shear waves at a position, X_{T}, located at a known distance ΔT from X_{P2}. In some embodiments, the method comprises the step of: laterally translating the “push-track” pair at a distance for each axial depth to generate a two-dimensional elastogram. In some embodiments, the method comprises the step of: beamforming using a beamformer a modulated tracked dataset that is software. In some embodiments, the method comprises the step of: passing the beamformed data to a Doppler style displacement estimator, that estimates the displacement between two consecutive echo traces. In some embodiments, the method comprises the step of: processing the estimated displacement by frequency-domain transfer function estimator that estimates “phase delay” and amplitude decay over the frequency bandwidth. In some embodiments, the method further comprises the step of: processing the estimated displacement by time-domain cross-correlation “group-delay” estimator that estimates time delay between displacement-peaks.

In some embodiments, the method comprises the step of: projecting the shear wave speed and attenuation estimates to a modulus space by using the plane-wave approximation of shearwave propagation to render 2D multi-frequency μ_{E}, μ_{S}(ω), and μ_{L}(ω) elastograms.

In some embodiments, the ratio of ΔP to the estimated time delay provides a group wave-speed estimate, and the phase shift between echoes at a particular frequency provides a phase wave-speed estimate, while the amplitude decay provides an attenuation estimate.

Another aspect of the present application relates to a method for noise suppression in viscoelasticity imaging, the method comprising: acquiring a plurality of viscoelastic displacement datasets from a single track location (STL) imaging sequence using plane-wave imaging with multiple steered insonification angles; forming, from the plurality of viscoelastic displacement datasets, a compounded in-phase quadrature (IQ) dataset; estimating displacement fields from the compounded IQ dataset using a two-dimensional (2D) autocorrelation-based displacement estimator; discarding a subset of the compounded IQ dataset that fails to meet a predefined minimum energy threshold to eliminate noise-corrupted data frames; applying a directional spatial frequency filter to the estimated displacement fields to remove reflected wave artifacts; applying a temporal band-pass filter to the displacement fields to isolate frequencies within a target bandwidth; computing a complex shear modulus of a medium by performing a frequency-domain transfer function analysis between a first and second shear wavefield generated by acoustic radiation force (ARF) pushes at spatially offset locations; estimating, for each pixel of the imaging field, a storage modulus and a loss modulus as a function of shear wave dispersion and attenuation over the frequency bandwidth; averaging the storage modulus and the loss modulus pixel-wise based on a cross-correlation coefficient derived from the shear wavefields; calculating a magnitude squared coherence (MSC) parameter at each frequency band using a periodogram-based estimator to determine the coherence between the tracked shear waves from the first and second ARF pushes; generating a quality map based on the MSC parameter across the frequency spectrum; and suppressing noise in the final viscoelastogram by weighting, enhancing, or masking the storage and loss modulus estimates based on the frequency-dependent quality map.

In some embodiments, the autocorrelation-based displacement estimator comprises a Loupas-2D estimator with a spatial and temporal ensemble window of targeted parameters.

In some embodiments, the compounded IQ dataset is formed by coherent compounding of echo data from a plurality of steered plane-wave tracking angles.

In some embodiments, the directional spatial frequency filter comprises a directional band-stop filter configured to suppress artifacts arising from shear wave reflections.

In some embodiments, the temporal band-pass filter comprises a second-order filter configured to isolate frequencies in a range between 50 Hz and 1500 Hz.

In some embodiments, the frequency-domain transfer function comprises a cross-power spectral density function between the two tracked shear wavefields, normalized by the auto-spectral density of a first tracked wavefield.

In some embodiments, the MSC parameter is estimated using Welch's overlapped segment averaging (WOSA) periodogram.

In some embodiments, the quality map generated from the MSC parameter identifies spatial and frequency-specific regions of high signal reliability for subsequent viscoelasticity rendering.

In some embodiments, the method further comprises rendering a two-dimensional viscoelastic map comprising a storage modulus elastogram and a loss modulus elastogram, wherein the map is weighted or masked based on the quality map to enhance contrast and suppress noise artifacts.

In some embodiments, the acquisition comprises synthesizing between 16 and 30 STL-style datasets, each comprising displacement wavefields corresponding to a spatially varying tracking line and ΔT offset.

Another aspect of the present application relates to a method for quality assessment and noise suppression in viscoelasticity imaging, the method comprising: acquiring a plurality of displacement wavefields generated from a pair of acoustic radiation force (ARF) PUSH events applied at spatially offset locations in a single track location (STL) imaging sequence; tracking shear wave propagation from the ARF PUSH events using plane-wave imaging at multiple steered angles to generate echo data; forming a compounded in-phase quadrature (IQ) dataset from the echo data; estimating displacement fields from the compounded IQ dataset using an autocorrelation-based displacement estimator; calculating, at each spatial location and over a range of frequencies, a magnitude squared coherence (MSC) parameter between a first and a second tracked shear wavefield, wherein the MSC parameter is computed as the cross-spectral density between the two wavefields normalized by the auto-spectral densities of the individual wavefields; generating a frequency-dependent quality map across an imaging field-of-view (FOV) based on the MSC parameter; computing, for each pixel in the FOV, viscoelastic parameters including a storage modulus and a loss modulus derived from a frequency-domain transfer function based on the displacement field; and suppressing noise in the computed viscoelastic parameters by applying the quality map to enhance, weight, or mask pixel-wise modulus estimates at frequency bands where the MSC parameter indicates low coherence.

In some embodiments, the MSC parameter is computed using Welch's overlapped segment averaging (WOSA) periodogram estimation at each frequency band.

In some embodiments, the MSC parameter ranges between 0 and 1 and provides a frequency-specific quantitative measure of similarity between the first and second tracked shear wavefields.

In some embodiments, the MSC parameter is used to identify frequency bands with low measurement reliability due to wave decorrelation, attenuation, dispersion, or diffraction.

In some embodiments, the MSC-based quality map is used to mask spatial locations within the FOV that are not reliably excited by shear wave energy at a particular frequency.

In some embodiments, the viscoelastic parameters include a shear storage modulus (μS) and a shear loss modulus (μL), computed as functions of wave dispersion and attenuation.

In some embodiments, the ARF PUSH events are spatially separated by a pitch distance ΔP and temporally offset, and wherein the MSC calculation accounts for normalization of spectral power to address differential energy delivery at the PUSH locations.

In some embodiments, the suppression of noise comprises excluding modulus estimates from frequency bands having an MSC value below a predetermined coherence threshold.

In some embodiments, the quality map generated from the MSC parameter is rendered alongside a viscoelastogram as a pixel-wise confidence metric for clinical interpretation.

In some embodiments, the compounded IQ dataset is formed by coherently compounding echo data from a plurality of plane-wave insonification angles, and the displacement estimation is performed using a two-dimensional Loupas estimator.

The present application is further illustrated by the following examples that should not be construed as limiting. The contents of all references, patents, and published patent applications cited throughout this application, as well as the Figures and Tables, are incorporated herein by reference.

### EXAMPLES

### Example 1 A. Phantoms and Tissue Preparations

Viscoelastic phantoms were prepared using a similar procedure described in [S. Khan, S. Goswami, F. Feng, S. Hollenbach, M. M. Doyley and S. A. McAleavey, “Probing Tissue Viscoelasticity With STL Ultrasound Shear-wave Spectroscopy Using Cole-Cole Diagrams,” in IEEE Transactions on Biomedical Engineering, vol. 71, no. 3, pp. 916-928, March 2024]. The study also fabricated a bi-layer phantom, where the linear shear modulus was matched between two distinct layers while the viscoelasticity response was altered. For the bi-layer phantom, a 300 ml solution containing 60% evaporated milk

$$( \frac{volume}{volume} )$$

was mixed with 8% 200 bloom clear gelatin

$$( \frac{weight}{volume} )$$

and 0.5% cornstarch (Wegmans Food Market)

$$( \frac{weight}{volume} )$$

were mixed to produce the bottom layer. In contrast, the top layer excluded the evaporated milk. A medium chicken egg was boiled for 6-7 minutes at about 100° C., and the outer shell was removed with care. The sample was scanned in PBS as a phantom with a viscous core. Care was taken to ensure that the egg white had hardened during the boiling process, yet the center retained a viscous liquid.

Fresh ex vivo liver was sacrificed from a white male New Zealand rabbit (Charles River) and harvested; the largest lobe was scanned under degassed isotonic saline. We also conducted in vivo experiments on two 10-week-old C57BL/6J mice (Jackson Laboratory, Bar Harbor, ME, United States) for this study. The animal was positioned recumbently, and the liver area was shaved to acquire ultrasound data. All animal protocols were approved by the University of Rochester Committee on Animal Resources (UCAR).

The human placenta was procured at full term after delivery and scanned immediately in a water bath with B-mode guidance to avoid large veins that produce anomalous speckle brightness. This study reports measurements of four independent echographic planes on the placental tissue with both maternal and fetal surfaces at the transducer face.

Tissue samples for the rheometer test were prepared by selecting the area on the organ where ultrasound scans were performed. Several 20-mm-diameter sections were punctured using a biopsy punch. Samples were preserved in saline in scintillation vials until mounted on the test bench. Experiments were performed on the same day as the ultrasound scans to avoid dehydration and changes in mechanical properties.

### Example 2: Viscoelastic Imaging of Phantoms

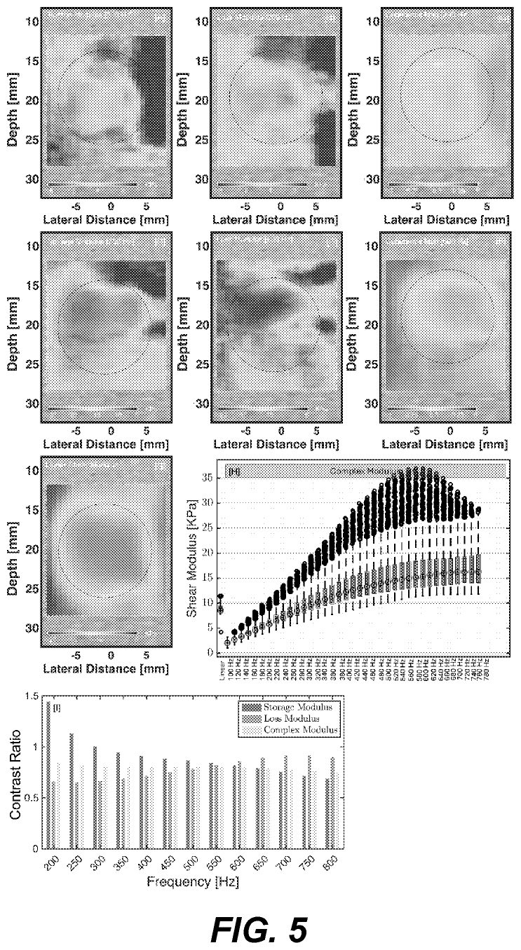

Subsequently, FIG. 5 shows imaging in a soft viscoelastic inclusion embedded in a stiffer viscoelastic background. Panels (A) and (D) show the storage modulus, while panels (B) and (E) show the loss modulus, respectively, captured at frequencies of 200 Hz and 600 Hz. Panels (C) and (F) show the MSC map with the inclusion. At lower frequencies, the inclusion target pixels are excited, suggesting softer fluid-like behavior, while at higher frequencies, the background pixels are brighter, suggesting solid-viscoelastic behavior. At 600 Hz, the coherence map shows that MSC values inside the inclusion boundary are lower than at 200 Hz, meaning the inclusion is excited at lower frequencies. The linear modulus parametric image obtained by the cross-correlation estimator is shown in (G), which shows that the inclusion is at least three times softer than the background in linear shear stiffness. Panel (H) shows that the average linear shear modulus in the inclusion region is 10 kPa, and the overall complex shear modulus derived from storage and loss modulus increases from 3 kPa at 100 Hz to five times its value at 15 kPa at 780 Hz. The viscoelastic modulus estimate variance at higher frequencies is noticeably higher than the linear modulus estimates. The contrast evaluation between the inclusion target and the surrounding background reveals that the loss modulus elastogram contrast over frequency is initially low and increases as the reconstruction frequency increases, as shown by the red bar in panel (I). The gray bar shows the contrast captured by the storage modulus elastogram, which decreases over the frequency range.

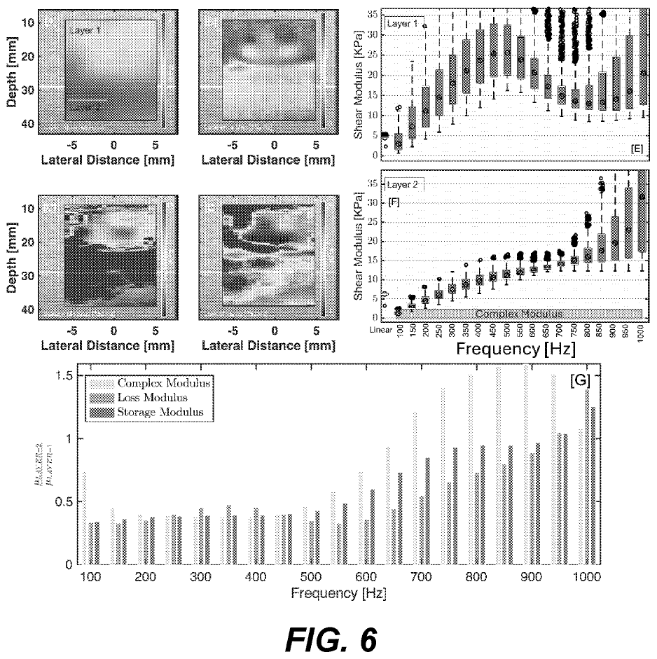

FIG. 6 shows images obtained in the bi-layer phantom. The phantom was designed to contain a negligible difference in group shear wave speed between the layers, meaning they would be similar in linear shear modulus. However, it would have different viscoelastic properties. Compared to the top, the condensed milk in the bottom layer changes its viscoelastic signature. Panel (A) shows the elastic shear modulus elastogram, indicating the two layers (Layer 2: μ_{E}=5 kPa, and Layer 1: μ_{E}=5.5 kPa). Panels (B)-(E) show the MSC, storage, and loss elastogram at 800 Hz. The viscoelastic signature of layers 1 and 2 are shown in Panels (E) and (F), respectively. It shows that although a negligible difference exists between the first data point in both graphs (representing the linear elastic modulus), the magnitude of the complex shear modulus over frequency between the layers is very different. Between the frequency range of 350-500 Hz, the dynamic modulus mismatch is apparent μ* is 20-25 kPa, while for Layer 2, the μ* is between 8-10 kPa. Panel (G) shows the mean magnitude of the complex shear modulus evaluated between Layer 2 and Layer 1, plotted as a function of frequency, which captures the difference as a ratio over the interrogated frequency range. Higher frequency modes are activated in Layer 2 at 850 Hz compared to Layer 1. The magnitude of the complex shear modulus ratio is also highest (1.5) around that frequency range.

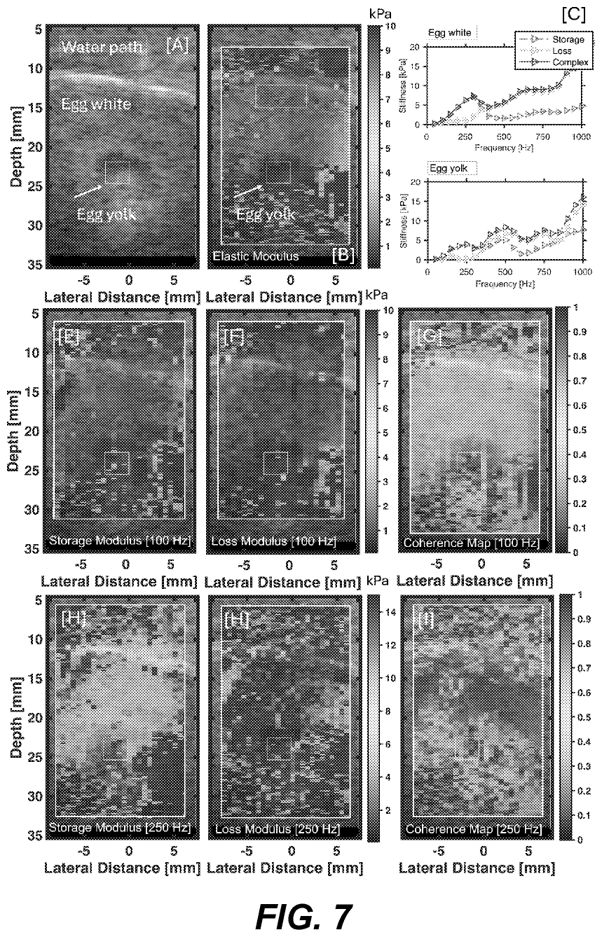

FIG. 7 demonstrates the elastography analysis of an intact boiled and peeled chicken egg phantom. Panel (A) displays the B-mode ultrasound image, highlighting the scan region, including the water path under which it is scanned, the solid egg white, and the liquid yolk at the center. Panel (B) presents the elastic modulus map, illustrating the spatial distribution of stiffness across the phantom, with stiffer regions corresponding to the egg white and softer regions associated with the yolk. Panel (C) plots the frequency-dependent stiffness variation within a 5 mm×5 mm ROI in the yolk region and a 5 mm×8 mm ROI in the egg-white region, showing the μ_{S}, μ_{L}, and μ* measured across a range of shear wave frequencies (50-1000 Hz). The average linear modulus in the yolk region is 0.2 kPa, μ_{S} is 3.9 kPa, while μ_{L} is 0.2 kPa at 250 Hz. Corresponding modulus values in the egg-white ROI are μ_{E} 0.95 kPa, μ_{S} is 6.2 kPa, while μ_{L} is 0.99 kPa at 250 Hz.

At higher shearwave frequencies, the μ_{L} dominates the overall stiffness of the ROI within the yolk, reaching up to 14 kPa around the frequency ranges of 800-1000 Hz, while the us contribution drops to 7-9 kPa around the same range. For the egg-white ROI, UL is 16.8 kPa and μ_{S} 4.6 kPa at 800 Hz. Panels (D-F) show spatial maps of the storage modulus, loss modulus, and MSC at 100 Hz, while panels (G-I) show corresponding maps at 250 Hz. MSC values around the egg-white region are generally higher than those of the yolk and around 1 at 250 Hz, compared to 0.6 at 100 Hz, implying better shear wave reconstruction quality within the egg-white region compared to that of the yolk.

### Example 3: Ex Vivo Imaging in Rabbit and Human Tissues

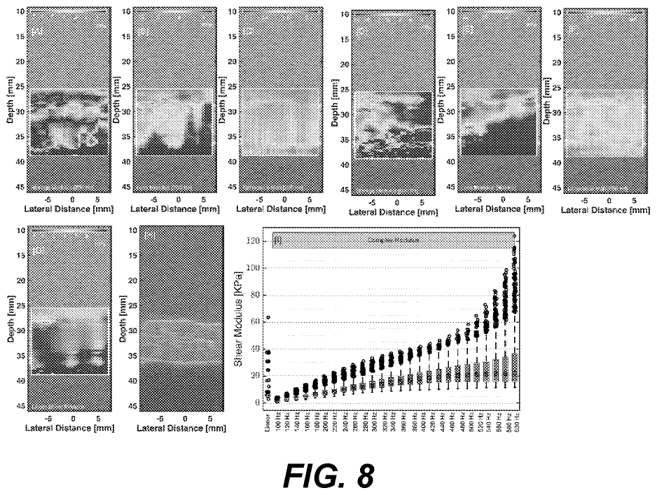

FIG. 8 shows elastograms in the ex vivo rabbit liver tissue embedded in a pure gelatin background. The liver is highlighted by enhanced echogenicity, outlining it in the B-mode image, as shown in Panel (H). The study renders the elastogram pixels around a square bounding box of 15×15 mm. Panels (A)-(C) show the storage, loss, and MSC images at 200 Hz, while panels (D)-(F) show the same maps for 600 Hz. Between panels (A) and (D), pixels representing the rabbit liver show that the average storage and loss moduli increase from 200 Hz to 600 Hz. The pixels representing the liver in the coherence map become brighter at 600 Hz (panel F) compared to 200 Hz (panel C), suggesting viscoelastic activation of the liver at 600 Hz mode. The overall stiffness represented by the magnitude of complex shear stiffness increases over the frequency range (20 kPa at 600 Hz), and this is also when compared to the linear shear stiffness (μ_{E}=5 kPa first data point in box-plot in Panel (I)). The variance of the dynamic modulus estimates increases at higher frequency moments.

When the study compares the viscoelastic modulus reported by the ultrasonic measurement with that obtained from the frequency sweep using the rheometer, as shown in Panel (A) of FIG. 10, the study observes that the trend of the magnitude of complex modulus (magenta curve) over frequency increases over the investigated frequency range which reaches 1 kPa at 15 Hz. The loss tangent (Tan δ) (black curve) represents the loss-to-storage modulus ratio that decreases to 2 over the probed frequency range, revealing a mild viscoelastic behavior of the sample up to 15 Hz.

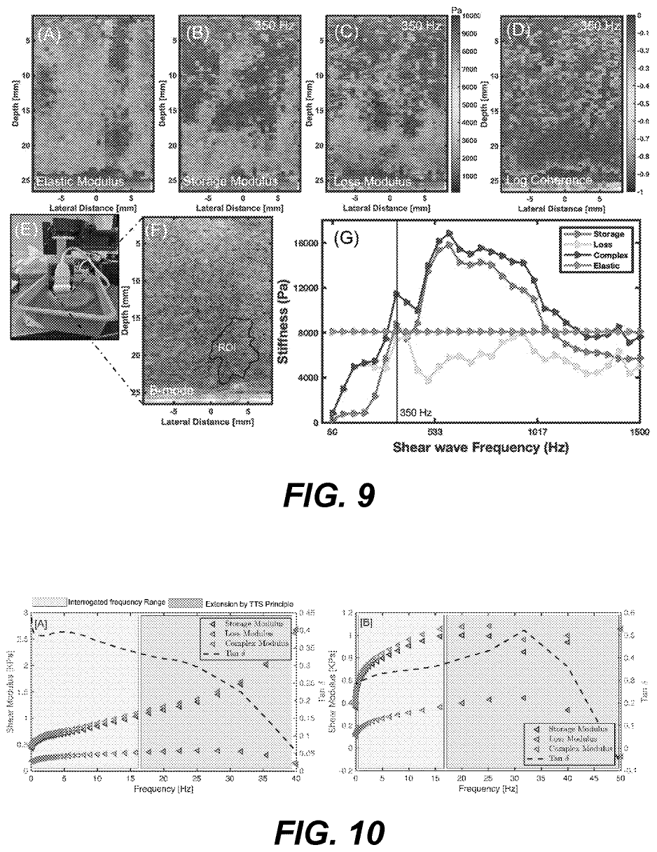

FIG. 9 shows viscoelastic imaging results in human ex vivo tissue. We report the local stiffness changes within a normal post-delivery full-term placenta evaluated by the μ_{E}, μ_{S}, and μ_{L}. The viscoelastograms (B, C) reveal contrast that is not visible in the corresponding elastogram (A). The viscoelastogram activation map, which also assesses imaging quality, is assessed using logarithmic transformation of the MSC estimate (D) of the wavefield at the shear wave reconstruction frequency (350 Hz). It shows high viscoelastic activation over most of the ROI at 350 Hz, where μ* is 11.8 kPa, whereas μ_{E} is 8 kPa. Panels (E-G) show the spectroscopic reconstruction with the transducer face over the fetal surface. The STL wavefield was averaged over an ROI selected in the sonogram (F), and elasticity estimates were computed over the shear wave reconstruction bandwidth (50-1500 Hz).

The study also corroborated the measurement using viscoelastic analysis on the placenta using the rheometer analysis as shown in Panel (B) of FIG. 10. We observe that both storage (blue curve) and loss (red curve) moduli increase over the interrogated frequency range. The magnitude of the complex modulus (magenta curve) increases up to 15 Hz (μ* is 1.2 kPa) and then remains flat up to 40 Hz. The Tan δ (black curve) increases up to 0.78 over that frequency and indicates that the viscous modulus constitutes the predominant component of the overall dynamic modulus.

### Example 4: Pre-Clinical In Vivo Imaging in Mice

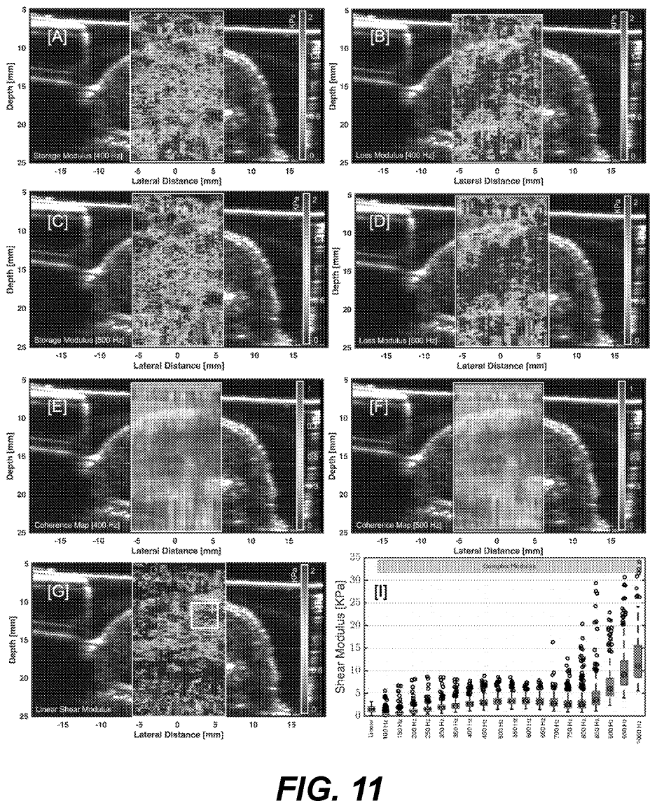

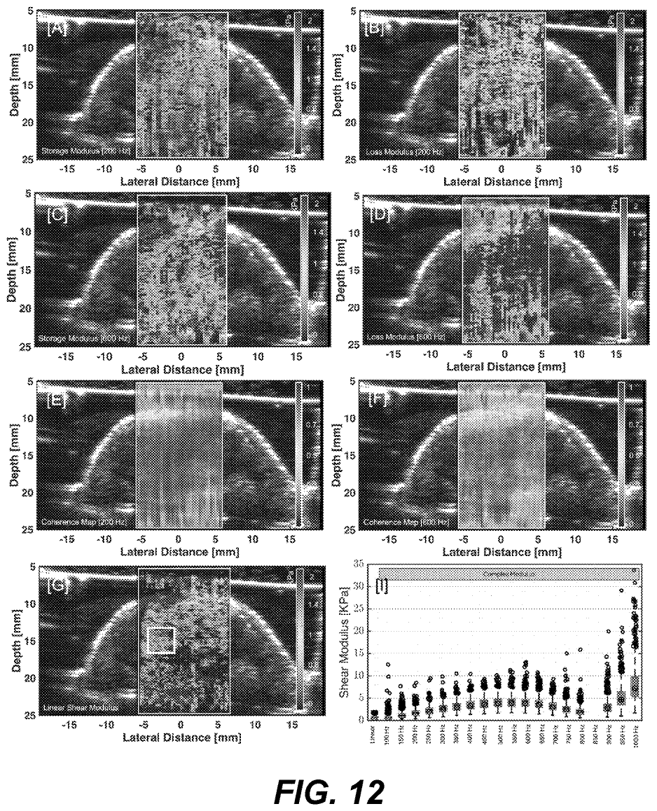

In this experiment, the study demonstrates the validation of our technique by pre-clinical in vivo imaging of mice livers (n=2) as shown in FIG. 11 for mouse 1 and in FIG. 12 for mouse 2. The panels (A and C) in both figures show the storage modulus at 400/200 and 500/600 Hz, respectively. Panels (B and D) show the loss modulus at 400 and 500 Hz. The MSC map is rendered at 400 and 500 Hz, as shown in panels (E and F). High coherence regions (MSC values near 1) correspond to areas with robust signal quality and or viscoelastic domination at that frequency. A large spatial reconstruction zone of the liver elastogram exhibits high MSC values. Panel (G) shows the linear modulus image. Panel (I) shows the mean μ* values within a 3.5 mm×3.5 mm ROI demonstrated by the white bounding box in (I) captured over 100-1000 Hz. Overall, the livers show an increase in stiffness at higher shearwave frequencies. The μE is below 1 kPa, while μ* reaches up to 10 kPa at 1000 Hz for mouse 1, while it reaches 5 kPa at 1000 Hz for mouse 2.

### Example 5: Limited Frequency Bandwith Model Fitting

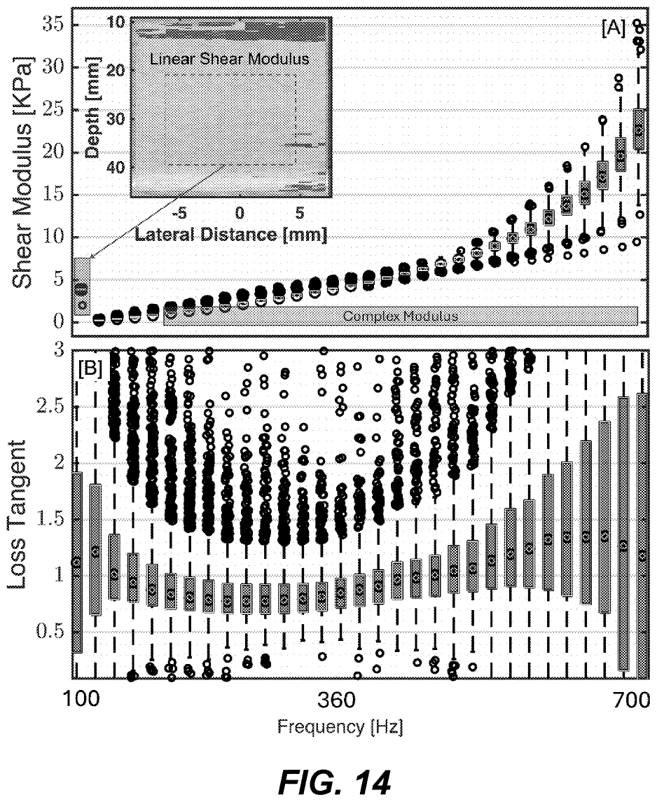

Based on the above conditions, the study chose to explore the magnitude of complex modulus signature over frequency to be a good candidate for investigating viscoelastic dynamics as shown in FIG. 14 Panel (A) for a viscoelastic phantom composed of an emulsion of 3% pure porcine gelatin (200 Bloom) and 3% castor-oil. The elastic modulus image is shown in-set with the ROI indicated, over which the viscoelastic analysis has been reported. The mean μ_{E} around the ROI is 4.8 kPa and μ* reaches up to 23 kPa at 700 Hz.

Another potential parametric imaging candidate is the loss tangent parameter, which is defined by the expression Tan δ=μ_{L}. The study plots the corresponding loss tangent estimate mapped over frequency in Panel (B) of FIG. 14. The mean Tan δ reported around the frequency range is around 1. Notably, the standard deviation around the mean of the estimate is much higher compared to Panel (A).

### Example 6: P-STL Viscoelasticity Imaging Algorithm

### Collect Raw Channel and IQ Data Pages

Perform GPU accelerated DAS beamforming [V. Perrot et al., Ultrasonics, vol. 111, p. 106309, 2021].

### Remove Noise Corrupted IQ Pages:

Select IQ pages 1 and 2.
Compute signal power of corrupted IQ frames.
Compute similarity metric to filter IQ data:

$${p}_{i} = \sum {IQ}_{1}^{2} , {p}_{2} = \sum {IQ}_{2}^{2} \qquad ( 6 )$$

$$similarity = \frac{\sum ( {IQ}_{1} \cdot {IQ}_{2} )}{\sqrt{{p}_{1} \cdot {p}_{2}}}$$

if similarity <threshold then Mark the first frame for removal as corrupted due to machine noise.
end if
In Phase-Quadrature Data Processing:
for all i∈1 . . . IQlen [parallelized] do
apply sliding window frame compounding [Y. Xiao et al. Ultrasound in Medicine & Biology, vol. 50, no. 2, pp. 198-206, 2024].
Perform displacement estimation between progressively referenced tracked [T. Loupas et al., IEEE Transactions on Ultrasonics, Ferroelectrics, and Frequency Control, vol. 42, no. 4, pp. 672-688, July 1995].
Apply band-pass filtering to limit shearwave frequencies between cut-off 50-1500 Hz.
Apply mean and median filtering using a spatial filtering kernel.
Apply spatial directional k-space filtering [T. Deffieux et al. EEE Transactions on Ultrasonics, Ferroelectrics, and Frequency Control, vol. 58, no. 10, pp. 2032-2035, 2011].
end for
Filtered shear wave dataset→wave
Shear Wave Analysis:
for all trackLines∈1 . . . numtrackLines [parallelized] do
Align wave data based on “PUSH-1” and “PUSH-2” indices.
   Compute shearwave speed, attenuation, and Magnitude-Squared-Coherence (MSC) for all FFT moments:
[groupSpeed, NCC]=time_of_flight (wave, Fs, pushSpacing)
   [TransferFunction, phaseSpeed, Attenuation]=spectral_processing (wave, Fs, pushSpacing)
[MSC]=coherenceCalculation (wave, frequency Stamp, Fs)
   Select elastogram reconstruction frequency bandwidth based on MSC cut-off values
   Compute the Complex modulus and the Loss Tangent for selected FFT moments:
      [StorageMod, LossMod; ElasticMod]=compute_complexModulus(frequencyStamp, phaseSpeed, Attenuation)
end for
Compute elastogram property averages based on NCC of frames given by Equation 4
Overlay parametric images on B-mode for rendering.

While various embodiments have been described above, it should be understood that such disclosures have been presented by way of example only and are not limiting. Thus, the breadth and scope of the subject compositions and methods should not be limited by any of the above-described exemplary embodiments but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

What is claimed is:

1. A method of mapping viscoelasticity using Acoustic Radiation Force (ARF) source Single Track Location (STL) shear wave spectroscopic imaging comprising:
generating shear waves in a body region of interest in a subject from a plurality of spatially offset locations;
tracking the shear waves at a common receiver;
measuring frequency-dependent shear wave speed;
measuring attenuation of the shear waves;
estimating by a crosspower spectral density (CPSD) transfer function a phase shift and an amplitude decay as a function of propagation distance; and
constructing multifrequency parametric two-dimensional maps capturing local tissue viscoelasticity.

2. The method of claim 1, where viscoelasticity is resolved over 50-1000 Hz.

3. The method of claim 1, where the subject is a mammal.

5. The method of claim 1, where the spatially offset locations are in a pair that is laterally shifted sequentially along the body region.

6. The method of claim 1, comprising the further step of:
generating shear waves by an acoustic radiation force “push” that is exerted at two spatial points (a “push-track” pair) at a particular depth, X_{P1} and X_{P2}, which are offset by a specific distance Δp.

7. The method of claim 6, comprising the further step of:
tracking the generated shear waves at a position, X_{T}, located at a known distance ΔT from X_{P2}.

8. The method of claim 7, comprising the further step of:
laterally translating the “push-track” pair at a distance for each axial depth to generate a two-dimensional elastogram.

9. The method of claim 8, comprising the further step of:
beamforming using a beamformer a modulated tracked dataset that is software.

10. The method of claim 9, comprising the further step of:
passing the beamformed data to a Doppler style displacement estimator, that estimates the displacement between two consecutive echo traces.

11. The method of claim 10, comprising the further step of:
processing the estimated displacement by frequency-domain transfer function estimator that estimates “phase delay” and amplitude decay over the frequency bandwidth.

12. The method of claim 10, comprising the further step of:
processing the estimated displacement by time-domain cross-correlation “group-delay” estimator that estimates time delay between displacement-peaks.

13. The method of claim 1, comprising the further step of:
projecting the shear wave speed and attenuation estimates to a modulus space by using the plane-wave approximation of shearwave propagation to render 2D multi-frequency μ_{E}, μ_{S}(ω), and μ_{L} (ω) elastograms.

14. The method of claim 6, wherein the ratio of ΔP to the estimated time delay provides a group wave-speed estimate, and the phase shift between echoes at a particular frequency provides a phase wave-speed estimate, while the amplitude decay provides an attenuation estimate.

15. A method for noise suppression in viscoelasticity imaging, the method comprising:
acquiring a plurality of viscoelastic displacement datasets from a single track location (STL) imaging sequence using plane-wave imaging with multiple steered insonification angles;
forming, from the plurality of viscoelastic displacement datasets, a compounded in-phase quadrature (IQ) dataset;
estimating displacement fields from the compounded IQ dataset using a two-dimensional (2D) autocorrelation-based displacement estimator;
discarding a subset of the compounded IQ dataset that fails to meet a predefined minimum energy threshold to eliminate noise-corrupted data frames;
applying a directional spatial frequency filter to the estimated displacement fields to remove reflected wave artifacts;
applying a temporal band-pass filter to the displacement fields to isolate frequencies within a target bandwidth;
computing a complex shear modulus of a medium by performing a frequency-domain transfer function analysis between a first and second shear wavefield generated by acoustic radiation force (ARF) pushes at spatially offset locations;
estimating, for each pixel of the imaging field, a storage modulus and a loss modulus as a function of shear wave dispersion and attenuation over the frequency bandwidth;
averaging the storage modulus and the loss modulus pixel-wise based on a cross-correlation coefficient derived from the shear wavefields;
calculating a magnitude squared coherence (MSC) parameter at each frequency band using a periodogram-based estimator to determine the coherence between the tracked shear waves from the first and second ARF pushes;
generating a quality map based on the MSC parameter across the frequency spectrum; and
suppressing noise in the final viscoelastogram by weighting, enhancing, or masking the storage and loss modulus estimates based on the frequency-dependent quality map.

16. The method of claim 15, wherein the autocorrelation-based displacement estimator comprises a Loupas-2D estimator with a spatial and temporal ensemble window of targeted parameters.

17. The method of claim 15, wherein the compounded IQ dataset is formed by coherent compounding of echo data from a plurality of steered plane-wave tracking angles.

18. The method of claim 15, wherein the directional spatial frequency filter comprises a directional band-stop filter configured to suppress artifacts arising from shear wave reflections.

19. The method of claim 15, wherein the temporal band-pass filter comprises a second-order filter configured to isolate frequencies in a range between 50 Hz and 1500 Hz.

20. The method of claim 15, wherein the frequency-domain transfer function comprises a cross-power spectral density function between the two tracked shear wavefields, normalized by the auto-spectral density of a first tracked wavefield.

21. The method of claim 15, wherein the MSC parameter is estimated using Welch's overlapped segment averaging (WOSA) periodogram.

22. The method of claim 15, wherein the quality map generated from the MSC parameter identifies spatial and frequency-specific regions of high signal reliability for subsequent viscoelasticity rendering.

23. The method of claim 15, further comprising rendering a two-dimensional viscoelastic map comprising a storage modulus elastogram and a loss modulus elastogram, wherein the map is weighted or masked based on the quality map to enhance contrast and suppress noise artifacts.

24. The method of claim 15, wherein the acquisition comprises synthesizing between 16 and 30 STL-style datasets, each comprising displacement wavefields corresponding to a spatially varying tracking line and ΔT offset.

25. A method for quality assessment and noise suppression in viscoelasticity imaging, the method comprising:
acquiring a plurality of displacement wavefields generated from a pair of acoustic radiation force (ARF) PUSH events applied at spatially offset locations in a single track location (STL) imaging sequence;
tracking shear wave propagation from the ARF PUSH events using plane-wave imaging at multiple steered angles to generate echo data;
forming a compounded in-phase quadrature (IQ) dataset from the echo data;
estimating displacement fields from the compounded IQ dataset using an autocorrelation-based displacement estimator;
calculating, at each spatial location and over a range of frequencies, a magnitude squared coherence (MSC) parameter between a first and a second tracked shear wavefield, wherein the MSC parameter is computed as the cross-spectral density between the two wavefields normalized by the auto-spectral densities of the individual wavefields;
generating a frequency-dependent quality map across an imaging field-of-view (FOV) based on the MSC parameter;
computing, for each pixel in the FOV, viscoelastic parameters including a storage modulus and a loss modulus derived from a frequency-domain transfer function based on the displacement field; and
suppressing noise in the computed viscoelastic parameters by applying the quality map to enhance, weight, or mask pixel-wise modulus estimates at frequency bands where the MSC parameter indicates low coherence.

26. The method of claim 25, wherein the MSC parameter is computed using Welch's overlapped segment averaging (WOSA) periodogram estimation at each frequency band.

27. The method of claim 25, wherein the MSC parameter ranges between 0 and 1 and provides a frequency-specific quantitative measure of similarity between the first and second tracked shear wavefields.

28. The method of claim 25, wherein the MSC parameter is used to identify frequency bands with low measurement reliability due to wave decorrelation, attenuation, dispersion, or diffraction.

29. The method of claim 25, wherein the MSC-based quality map is used to mask spatial locations within the FOV that are not reliably excited by shear wave energy at a particular frequency.

30. The method of claim 25, wherein the viscoelastic parameters include a shear storage modulus (μS) and a shear loss modulus (μL), computed as functions of wave dispersion and attenuation.

31. The method of claim 25, wherein the ARF PUSH events are spatially separated by a pitch distance ΔP and temporally offset, and wherein the MSC calculation accounts for normalization of spectral power to address differential energy delivery at the PUSH locations.

32. The method of claim 25, wherein the suppression of noise comprises excluding modulus estimates from frequency bands having an MSC value below a predetermined coherence threshold.

33. The method of claim 25, wherein the quality map generated from the MSC parameter is rendered alongside a viscoelastogram as a pixel-wise confidence metric for clinical interpretation.

34. The method of claim 25, wherein the compounded IQ dataset is formed by coherently compounding echo data from a plurality of plane-wave insonification angles, and the displacement estimation is performed using a two-dimensional Loupas estimator.
